(19) United States
(12) Patent Application Publication
(10) Pub. No.: US 2025/0385907 A1
(43) Pub. Date: Dec. 18, 2025

(54) DATING APPLICATION WITH IMPROVED SECURITY FEATURES

(71) Applicant: Datesafe LLC, Red Lodge, MT (US)

(72) Inventors: Kaidan STASKOWSKI, New York, NY (US); Harlan AUERBACH, New York, NY (US); Darin FRANK, Park Ridge, NJ (US)

(73) Assignee: Datesafe LLC, Red Lodge, MT (US)

(21) Appl. No.: 18/741,709

(22) Filed: Jun. 12, 2024

(51) Int. Cl. H04L 9/40; G06Q 50/00

(52) U.S. Cl. CPC H04L 63/0861; G06Q 50/01

(57) ABSTRACT

A system and method for providing secure online dating. The system uses government issued identification and matches this information with public information and known ID attributes. Biometric information extracted from video data and information extracted from ID attributes are used to verify the identity of the user.

### TECHNICAL FIELD

This application relates to online dating services and, in particular, to enhanced security features for use with online dating services.

### BACKGROUND

Online dating enables people to find and introduce themselves to potential connections over the Internet, usually with the goal of developing relationships. An online dating service is a service that provides specific mechanisms, such as mobile applications, for online dating through the use of Internet-connected personal computers or mobile devices. Such services offer a wide variety of unmoderated matchmaking, most of which are profile-based.

Online dating services allow users to create a profile and upload personal information including age, gender, sexual orientation, location, appearance, photos and videos. Once a profile has been created, members can view the profiles of other members of the service, using the profile information to decide whether or not to initiate contact. Services offer digital messaging, webcasts, online chat, telephone chat, and message boards. Members can constrain their interactions to the online space, or they can arrange a date to meet in person.

A variety of online dating services currently exists. Some have a broad membership base of diverse users looking for many different types of relationships. Other sites target highly specific demographics based on features like shared interests, location, religion, sexual orientation, or relationship type. Online dating services also differ widely in their revenue streams. Some sites are completely free and depend on advertising for revenue. Others utilize the freemium revenue model, offering free registration and use, with optional, paid, premium services. Still others rely solely on paid membership subscriptions.

One of the drawbacks associated with conventional online dating activities involves identity verification. Conventionally, a user creates a profile using photos and his contact information, but there is often no way to ensure that the user is utilizing photos of himself or herself and that the contact information he or she inputs is correct. This provides cover for bad actors who intend to “catfish” other users, take advantage of other users and/or waste the time of others. This is a disadvantage to users who intend to make connections with other real people with the goal of developing relationships.

Therefore, a system and method for improving security and ensuring the identity of users is needed to protect the consumer.

### SUMMARY

The present disclosure is directed to online dating systems and methods that verify identity of a user.

An aspect of the application is an online dating. The online dating system comprising a server; a device adapted to be operably connected to the server, wherein the device is adapted to transmit video data to the server, wherein the video data comprises at least user imagery from a user and identification data from a government issued identification; wherein the server is adapted to receive the video data at the server; wherein the server is adapted to extract biometric data from the user imagery; wherein the server is adapted to extract identification data from video data at the server, wherein the identification data comprises physical data and identity data; wherein the server is adapted to determine validity of the government issued identification using the extracted identification data; wherein the server is adapted to provide a comparison score based on the extracted biometric data from the user imagery and extracted biometric data from the physical data; wherein the server is adapted to use the comparison score and determined validity of the government issued identification to verify identity of the user; and wherein the server is adapted to use verification of the identity of the user when interacting with the online dating system.

Another aspect of the present disclosure is a method for verifying identity of a user of an online dating system. The method comprising: transmitting video data from a device to server, wherein the video data comprises at least user imagery and images of a government issued identification; receiving the video data at the server; extracting biometric data from the user imagery; extracting identification data from the government issued identification of the user; determining validity of the government issued identification from the physical data and identity data extracted from the identification data; determining a comparison score based on the extracted biometric data from user imagery and extracted biometric data from the physical data from the identification data; verifying identity of the user based on the comparison score and the validity of the government issued identification; and permitting interaction with the online dating system based on the verification of identity of the user.

### BRIEF DESCRIPTION OF THE DRAWINGS

The foregoing summary, as well as the following detailed description of illustrative embodiments of the present application, will be better understood when read in conjunction with the appended drawings. For illustrating the present application, shown in the drawings are embodiments of the disclosure. It should be understood, however, that the application is not limited to the precise arrangements and instrumentalities shown.

FIG. 1 shows a diagram of the online dating system.

FIG. 2 is a diagram of the online dating system and use of the video data.

FIG. 3 is a diagram illustrating the extraction of and use of biometric data from the video data.

FIG. 4 is a flow chart of the method for validating a user for the online dating system.

### DETAILED DESCRIPTION OF ILLUSTRATIVE EMBODIMENTS

To facilitate an understanding of embodiments, principles, and features of the present disclosure, they are disclosed hereinafter with reference to implementation in illustrative embodiments. Embodiments of the present disclosure, however, are not limited to use in the described systems or methods and may be utilized in other systems and methods as will be understood by those skilled in the art.

The components described hereinafter as making up the various embodiments are intended to be illustrative and not restrictive. Many suitable components that would perform the same or a similar function as the components described herein are intended to be embraced within the scope of embodiments of the present disclosure.

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The disclosed embodiments enhance online dating security by verifying the identity of users. A user enters data into an application on a computer or mobile device. This information can include data regarding the individual as well as video imagery. The video imagery can include visual data related to the user. The visual data can be videos and photos of the user. The video data can also include information related to government issue identification. This data is then processed to extract those features and qualities that are effective in verifying the identity of the user of the application.

The disclosed embodiments reduce or eliminate the possibility that a scammer, a “cat fisher,” or a bad actor is hiding or obscuring their actual identity while using an online dating application. This is advantageous for users and their friends or acquaintances, as it provides greater accuracy in ensuring that users of an online dating application are who they say they are. An additional benefit of the disclosed embodiments is the immediate transmission of user identify verification to a user's mobile device, which allows the recipient to immediately start using the online dating application. A benefit of the claimed subject matter is the improvement of the conventional online dating experience by insuring user identity, which results in more security and fewer negative experiences relating to false identities. When users are sure they are speaking to actual, verified users, they can better enjoy the online dating experience. The claimed subject matter also allows for safer and more secure communications and dating in general.

The verification of a user's identity is accomplished by using the following method and systems. The system and methods disclosed herein can enhance the security of the online dating system and the verification of the identity of the user.

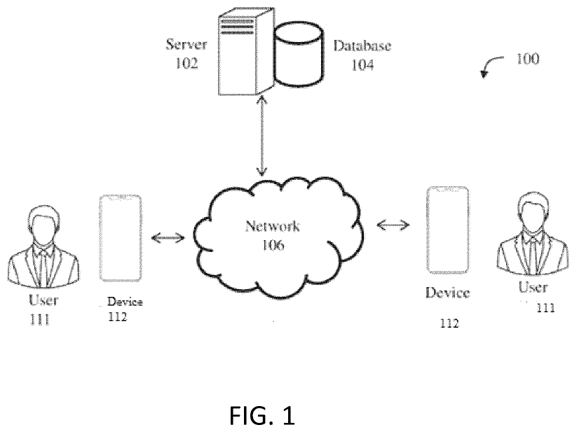

Referring now to the drawing figures in which like reference designators refer to like elements, there is shown in FIG. 1 online dating system 100, in accordance with an embodiment of the disclosure. Online dating system comprises a server 102 and a database 104 operably connected to a network 106 through which users 111 and devices 112 access the server 102. Server 102, database 104, and devices 112 include program logic such as computer programs, mobile applications, executable files, or computer instructions, including computer source code, scripting language code, or interpreted language code, that may be compiled to produce an executable file or that may be interpreted at run-time, that perform various functions of the disclosed embodiments.

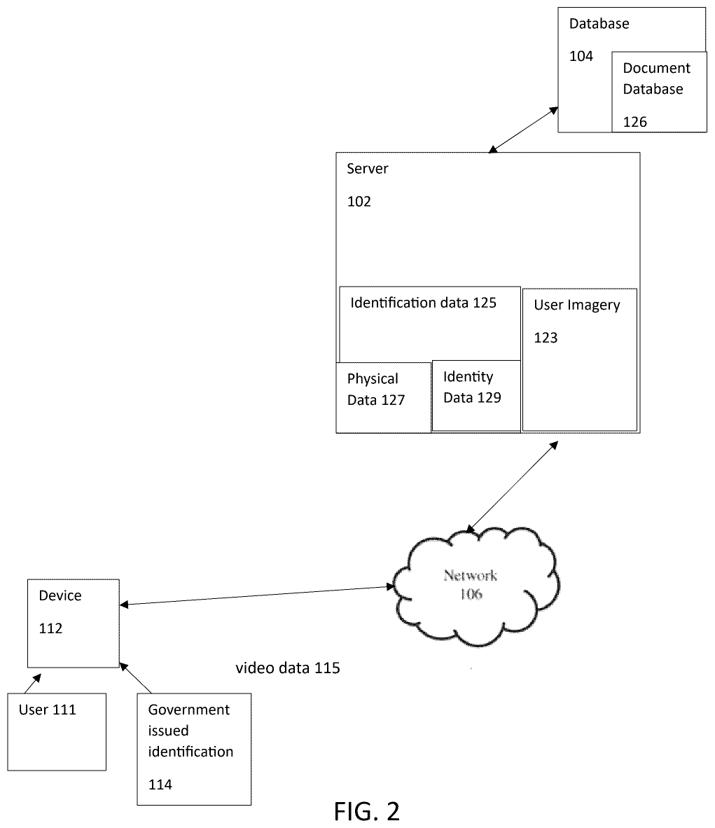

Server 102 has implemented thereon the software applications that configure the server 102 to be adapted to process and analyze data received from users 111 and devices 112. Further discussion of the server 102 and the analysis of the data received from the users 111 and the devices 112 is discussed below with reference to FIG. 2. Server 102 may be one of a plurality of servers or have its functionality distributed on multiple servers. Database 104 may be one of a plurality of databases and is operably connected to the server 102. The database 104 is adapted to store data that can be accessed by the server 102. The server 102 is operably connected to the network 106 and transmits and receives data over the network 106.

In an embodiment, database 104 a relational database comprising a Structured Query Language (SQL) database stored in a SQL server. The devices 112 may also each include their own database. The database 104 serves data during operation of the disclosed embodiments. Database 104 may be distributed over one or more nodes or locations that are connected via network 106.

In an embodiment, the database 104 includes a record for each user 111. In an embodiment, a user record may include contact/identifying information for the user (name, address, telephone number(s), email address, etc.), information pertaining to other users associated with the user (such as dating partners), electronic payment information for the user, information pertaining to the communications made by the user, sales transaction data associated with the user, etc. In an embodiment, a user record may also include a unique identifier for each user, a residential address for each user, the current location of each user (based on location-based services from the user's mobile computer) and a description of past online dating services purchased by each user. In an embodiment, a user record may further include demographic data for each user, such as age, sex, income data, race, color, marital status, etc. In an embodiment, a user record may also include dating preferences of the user.

In an embodiment, the database 104 may include a user profile record for each user 111. In an embodiment, a user profile may include any of the data associated with a user record discussed above. In an embodiment, a user profile may also include user contact information entered via the client computing device, as well as video data related to the user 111.

Network 106 can be a circuit switched network, such as the Public Service Telephone Network (PSTN), a packet switched network, such as the Internet or the World Wide Web, telephone network, a cellular network, a mobile communications network, or any combination of the above.

Users 111 and devices 112 are adapted to communicate via the network 106 with the server 102. Devices 112 may be, computers, smart phones, mobile phones, tablet computers, handheld computers, laptops, or other computational devices, workstations, desktop computers, servers, laptops, all-in-one computers, or the like, adapted to communicate via the network 106. In an embodiment, devices 112, are AR or VR systems that may include display screens, headsets, heads up displays, helmet mounted display screens, tracking devices, or the like. Augmented reality (AR) adds digital elements to a live view often by using a camera on a computing device. Virtual reality (VR) is a complete or near complete immersion experience that replaces the physical world. Devices 112 may be communicatively coupled with network 106 in a wired or wireless fashion. The devices 112 have running thereon applications or can access via browsers, the online dating system 100.

### Public Information Based Identity Verification

Referring now to FIG. 2, a user 111 uses a government issued identification 114 to verify his or her identity. User 111 uses device 112 to capture video imagery of the government issued identification 114. User 111 can also use the device 112 to capture video imagery of the user 111. The video imagery of the user 111 and the video imagery of the government issued identification comprise the video data 115 that is transmitted to server 102. The video imagery can be video, still photos, or a combination of both.

At server 102, the identification data 125 is extracted from the video data 115. The identification data 125 contains those features from the government issued identification 114 that assist in establishing the validity of the government issued identification 114. Additionally, user imagery 123 is extracted from the video data 115.

Identification data 125 can be physical data 127, which are features of the government issued identification 114, such as the width, length, coloring, holograms, hologram placement, placement of letters, borders, font color, text placement, image size, image color, image placement, ID positioning, and picture dimensions. The identification data 125 can also be identity data 129 extracted from the identification data 125, for example, birthdate, license numbers, social security numbers, passport numbers, addresses, issuing authority, expiration dates, issue dates, photographic data, and gender. Identification data 125 pulled from the ID varies depending on the type of ID.

The physical data 127 can be compared to information and data in a document database 126 regarding physical features of government issued identification 114. Document database 126 may be part of server 104, or a separate database. This can help establish whether the government issued identification 114 is legitimate. The comparison of the identification data 125 with existing physical features within the document database 126 can be used to generate a metric. For example, a number (e.g., between 1-10) corresponding to the potential validity of the government issued identification 114 can be generated.

The identity data 129 that is not related to the physical features of the government issued identification 114 is compared with information that is retrieved from publicly available data over the network 106. Correlations are made with existing social networking information, address information, etc. Comparisons can include comparisons of photos and data related to relations and relationships. All the information found related to a user is then compared against the identity data 129. This information is used by the sever 102 to establish a metric for the validity of the government issued identification 114. The information gathered from the network 106 can further be used to provide a metric for the government issued identification 114.

The metric for the physical data 127 can be combined with the metric from the identity data 129 to provide a composite of the two metrics. In an embodiment, the physical data 127 and its metric can be given greater weight than the identity data 129 and its metric. In an embodiment, the identity data 129 and its metric can be given greater weight than the physical data 127 and its metric. In an embodiment, the identity data 129 and its metric can be given equal weight to the physical data 127 and its metric.

In an embodiment, the identity data 129 and its metric can be variable weight with respect to the physical data 127 and its metric. For example, contextualized information regarding the identity data 129 and physical data 127 can be used to vary the weight for a particular metric. For example, if it was known that an increase in well-crafted fake government identification 114 was coming from a particular region, less weight may be given to the metric for the physical data 127 coming from that region.

Regionality of identification data 125 may be established from information other than the information provided by the user. For example, the identification data 125 may be sourced by IP address or cell tower.

When the metrics exceed a certain threshold, the identification data 125 related to the government issued identification 114 is established as valid. The online dating system 100 then takes the user imagery 123 and compares it to the validated identification data 125 to determine the validity the user 111. Verification of the user imagery 123 and the imagery from the physical data 127 is discussed further below.

### Biometric-Based Online Dating Profile Verification

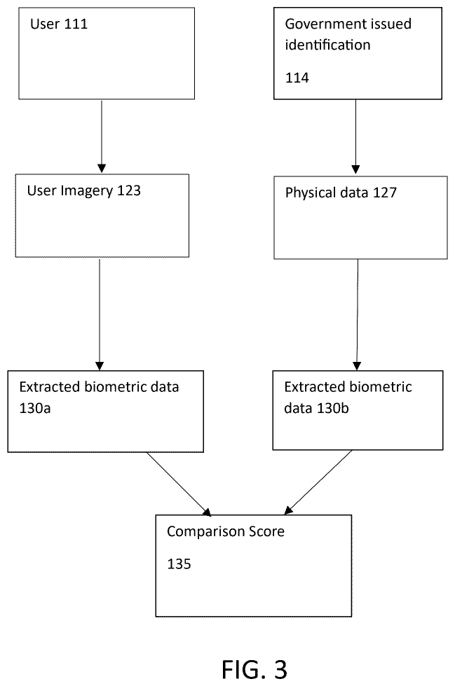

Referring now to FIG. 3, another aspect of the online dating system 100 is the utilization of biometric based data for continued verification of information that is placed on a user's account. After verification of the government issued identification 114 as discussed above using the identification data 125, the user imagery 123 is compared to visual data that is extracted from the identification data 125. For example, biometric data 130a from the user imagery 123 is compared with biometric data 130b from photographs contained in the identification data 125.

The server 102 is adapted to take the user imagery 123 and extract biometric data 130a from a user's face. The biometric data 130a may include features of the user's face may include hair color, eye color, nose shape, nose size, skin tone, eye size, distance between eyes, eyebrow shape, eyebrow color, jaw shape, jaw size, and forehead size. The server 102 also extracts similar biometric data 130b from the identification data 125.

Generally, the biometric data that is extracted can be commensurate with features commonly perceived in government issued identification 114. For example, biometric data 130a features may include facial structure, which includes the overall shape of the face, such as round, oval, square, etc. Facial symmetry, which includes the degree to which the left and right sides of the face match. Eye color, which is the color of the irises that vary from person to person. Eye distance, which is the distance between the eyes. The shape of the eyes, including aspects like almond-shaped, round, etc. The shape, thickness, and arch of the eyebrows, which can be unique to individuals. Nose shape and size. The length, and shape of the nose can vary significantly among individuals. Mouth shape and size. The size and shape of the mouth, including features like lip thickness and width. The contour and shape of the jaw. The shape and prominence of the chin. Ear shape, size, and position. The shape and pattern of the hairline along the forehead. The color and texture of the hair on the head and face. The texture and color of the skin on the face and neck. To the extent visible, shoulder width.

Referring to FIG. 3, the extracted biometric data 130a from the user imagery 123 taken from the user 111 is compared with the extracted biometric data 130b from the physical data 123 taken from the government issued identification 114. The extracted biometric data 130b and 130a are compared and used to determine a comparison score 135.

Sample comparison scorings are as follows: Facial Symmetry: perfect symmetry: 10 points, slight asymmetry: 7 points, significant asymmetry: 5 points, extreme asymmetry: 2 points; eye distance: ideal distance: 10 points, slightly wider/narrower: 8 points, moderately wider/narrower: 5 points, significantly wider/narrower: 3 points; eye color: exact match: 10 points, similar color: 7 points, different color: 3 points, eye shape: exact match: 10 points, similar shape: 8 points, different shape: 5 points, eyebrows: exact match: 10 points, similar shape: 8 points, different shape: 5 points; nose shape and size: exact match: 10 points, similar shape: 8 points, different shape: 5 points; mouth shape and size: exact match: 10 points, similar shape: 8 points, different shape: 5 points; jawline: exact match: 10 points, similar contour: 8 points, different contour: 5 points; chin structure: exact match: 10 points, similar structure: 8 points, different structure: 5 points; ear shape and size: exact match: 10 points, similar shape: 8 points, different shape: 5 points; hairline: exact match: 10 points, similar pattern: 8 points, different pattern: 5 points, hair color and texture: exact match: 10 points, similar color/texture: 8 points, different color/texture: 5 points; skin texture and complexion: exact match: 10 points, similar texture/complexion: 8 points, different texture/complexion: 5 points; shoulder width: exact match: 10 points, similar width: 8 points, different width: 5 points.

The comparison score 135 is generated using at least some of the comparisons discussed above. A threshold for the comparison score 135 can be used to either pass the certification or deny it. The threshold score can be predefined but can be adjusted. If the comparison score 135 exceeds the threshold, the online dating system 100 verifies the identity of the user 111. If the score is below the threshold, the system indicates that the user imagery 123 is invalid.

Once the online dating system 100 verifies that the user 111 is who they say they are. The user imagery 123 can be stored and used as an additional resource in which to further validate images uploaded by the user 111. The online dating system 100 can also verify the user 111 by utilizing live video of a user 111. The process discussed above, in which comparison scores 135 are used to verify data can be utilized for all uploaded data.

Future images and video data uploaded to the online dating system 100 can be verified to ensure that all images that are on a user's account are valid. This is accomplished in group photos as well as individual photos.

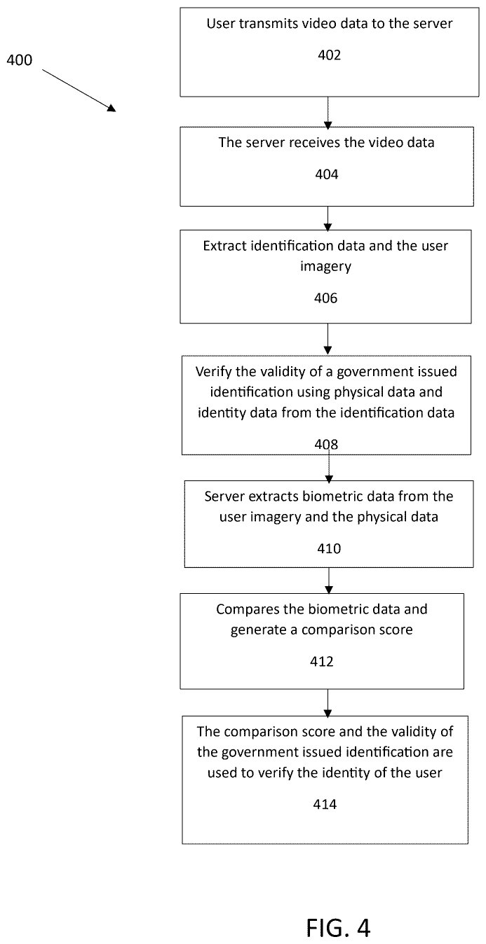

FIG. 4 shows the method of validation utilized by the online dating system 100. The validation method 400 shown in FIG. 4 provides verification of identity and the photos and videos of the user 111. Reference is generally made to FIGS. 1-3, in describing the method 400. In step 402, the user 111 transmits video data 115 via a network 106 to the server 102. The video data 115 having the video and/or phots of the user 111 and at least one government issued identification 114. In step, 404 the server 102 receives the video data 115.

In step 406, the server 102 takes the video data 115 and extracts the identification data 125 related to the government issued identification 114 and the user imagery 123 of the user 111.

In step 408, the server 102 verifies the validity of the government issued identification using physical data 127 and identity data 129 extracted from the identification data 125.

In step 410, the server 102 extracts biometric data 130a and 130b from the user imagery 123 and the physical data 127.

In step 412, the server 102 compares the biometric data 130a and 130b and generates a comparison score 135.

In step 414, the comparison score 135 and the verification of the validity of the government issued identification 114 are used to verify the identity of the user 111. This permits continued use of the online dating system 100.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general-purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, optical technology, CD-ROM, or other forms of RAM or ROM. Further, the disclosed methods' stages may be modified in any manner, including by reordering stages and/or inserting or deleting stages, without departing from the claimed subject matter.

Wherever possible, the same or like reference numbers are used throughout the drawings to refer to the same or like features. It should be noted that the drawings are in simplified schematic form and are not drawn to precise scale. Certain terminology used in the description is for convenience only and is not limiting. For example, directional terms such as top, bottom, left, right, above, below and diagonal, are used with respect to the accompanying drawings. The words “inwardly” and “outwardly” refer to directions toward and away from, respectively, the geometric center of the identified element and designated parts thereof. Such directional terms used in conjunction with the following description of the drawings should not be construed to limit the scope of the present disclosure in any manner not explicitly set forth. Additionally, the term “a,” as used in the specification, means “at least one.” The terminology includes the words above specifically mentioned, derivatives thereof, and words of similar import.

“Substantially” as used herein shall mean considerable in extent, largely but not wholly that which is specified, or an appropriate variation therefrom as is acceptable within the field of art. “Exemplary” as used herein shall mean serving as an example.

“About” as used herein when referring to a measurable value such as an amount, a temporal duration, and the like, is meant to encompass variations of ±20%, ±10%, ±5%, ±1%, or ±0.1% from the specified value, as such variations are appropriate.

Throughout this disclosure, various embodiments of the present invention can be presented in a range format. It should be understood that the description in range format is merely for convenience and brevity and should not be construed as an inflexible limitation on the scope of the present invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of exemplary embodiments may be combined in any suitable manner in one or more embodiments. One skilled in the art will recognize, in light of the description herein, that the exemplary embodiments can be practiced without one or more of the specific features or advantages of a particular embodiment. In other instances, additional features and advantages may be recognized in certain embodiments that may not be present in all embodiments of the present disclosure.

While the disclosure is described herein, using a limited number of embodiments, these specific embodiments are not intended to limit the scope of the disclosure as otherwise described and claimed herein. The precise arrangement of various elements and order of the steps of articles and methods described herein are not to be considered limiting. For instance, although the steps of the methods are described with reference to sequential series of reference signs and progression of the blocks in the figures, the method can be implemented in any order as desired.

1. An online dating system comprising:
a server;
a device adapted to be operably connected to the server, wherein the device is adapted to transmit video data to the server, wherein the video data comprises at least user imagery from a user and identification data from a government issued identification;
wherein the server is adapted to receive the video data at the server;
wherein the server is adapted to extract biometric data from the user imagery;
wherein the server is adapted to extract identification data from video data at the server, wherein the identification data comprises physical data and identity data;
wherein the server is adapted to determine validity of the government issued identification using the extracted identification data;
wherein the server is adapted to provide a comparison score based on the extracted biometric data from the user imagery and extracted biometric data from the physical data;
wherein the server is adapted to use the comparison score and determined validity of the government issued identification to verify identity of the user; and
wherein the server is adapted to use verification of the identity of the user when interacting with the online dating system.

2. The online dating system of claim 1, wherein the video imagery includes data from a live video scan.

3. The online dating system of claim 2, wherein the server is adapted to take biometric data from the live video scan and compare it to biometric data from video imagery uploaded after receipt of the live video scan.

4. The online dating system of claim 3, wherein the video imagery uploaded after receipt of the live video scan is rejected if the biometric data from video imagery uploaded after receipt of the live video scan is below a threshold value of the comparison score.

5. The online dating system of claim 4, wherein the biometric data includes at least one of nose shape and size, distance between eyes, forehead metrics, and jaw shape and size.

6. The online dating system of claim 5, wherein the biometric data includes at least one of hair color, eye color, skin color, and eyebrow shape and color.

7. The online dating system of claim 1, wherein the identity data extracted from the government issued identification of the user includes format data of the government issued identification.

8. The online dating system of claim 7, wherein the format data includes at least one of font color and text placement.

9. The online dating system of claim 8, wherein the format data includes at least one of image size, image color, and image placement.

10. The online dating system of claim 9, wherein the format data is compared with publicly available data regarding the government issued identification and a metric is provided, wherein if the metric exceeds a threshold the government issued identification is verified.

11. A method for verifying identity of a user of an online dating system comprising:
transmitting video data from a device to server, wherein the video data comprises at least user imagery and images of a government issued identification;
receiving the video data at the server;
extracting biometric data from the user imagery;
extracting identification data from the government issued identification of the user;
determining validity of the government issued identification from the physical data and identity data extracted from the identification data;
determining a comparison score based on the extracted biometric data from user imagery and extracted biometric data from the physical data from the identification data;
verifying identity of the user based on the comparison score and the validity of the government issued identification; and
permitting interaction with the online dating system based on the verification of identity of the user.

12. The method of claim 11, wherein the video imagery includes data from a live video scan.

13. The method of claim 12, wherein biometric data from the live video scan is compared to biometric data from video imagery uploaded after receipt of the live video scan.

14. The method of claim 13, wherein the video imagery uploaded after receipt of the live video scan is rejected if the biometric data from video imagery uploaded after receipt of the live video scan is below a threshold value of the comparison score.

15. The method of claim 14, wherein the biometric data includes at least one of nose shape and size, distance between eyes, forehead metrics, and jaw shape and size.

16. The method of claim 15, wherein the biometric data includes at least one of hair color, eye color, skin color, and eyebrow shape and color.

17. The method of claim 11, wherein the identification data extracted from the government issued identification of the user includes format data of the government issued identification.

18. The method of claim 17, wherein the format data includes at least one of font color and text placement.

19. The method of claim 18, wherein the format data includes at least one of image size, image color, and image placement.

20. The method of claim 19, wherein the format data is compared against publicly available data regarding the government issued identification and a metric is provided, wherein if the score exceeds a threshold for the metric the government issued identification is verified.
